(19) United States
(12) Patent Application Publication
(10) Pub. No.: US 2008/0063248 A1
(43) Pub. Date: Mar. 13, 2008

(54) Image Processing Apparatus and Method

(75) Inventors: Stewart Young, Hamburg (DE); Daniel Bystrov, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/575,657

(22) PCT Filed: Sep. 20, 2005
(86) PCT No.: PCT/IB05/53087

§ 371 Date: Mar. 21, 2007

(30) Foreign Application Priority Data
Sep. 28, 2004 (EP) 04104703.6

(51) Int. Cl. G06K 9/00; G06T 15/00

(52) U.S. Cl. 382/128

(57) ABSTRACT

The present invention relates to an image processing apparatus (1) for processing a 3D image data set of an object of interest and for providing a projection image of said object of interest from a predetermined viewing angle for display. In order to provide an apparatus which enables real-time interactive editing of the contents of a projection view, such as a MIP view, an image processing apparatus is proposed comprising:
a segmentation unit (10) for segmentation of said 3D image data set to obtain a segmented 3D image data set,
a labelling unit (11) for labelling image voxels of the same image objects of the segmented 3D image data set to obtain labelled image objects,
an image generator (12) for generating projection images of said labelled image objects and of the background from said predetermined viewing angle,
a selector (13) for selecting one or more of said projection images for display,
an image processor (14) for generating the final projection image for display by combining the selected projection images.

The present invention relates to an image processing apparatus and a corresponding image processing method for processing a 3D image data set of an object of interest and for providing a projection image of said object of interest from a predetermined viewing angle for display.

Maximum intensity projection (MIP) is a commonly used technique for displaying 3D image data, in particular in medial imaging, for instance for displaying 3D vascular image data. In the latter case MIP relies on the blood in the vessel having a higher pixel intensity value than other organs of the imaged anatomy. This relationship, however, does not apply to certain types of tissues. In a CT image, for instance, the pixel intensity of bones tends to be of a higher value than that of blood vessels. Thus, in many instances in order to correctly display the blood vessels in a 3D reconstruction of CT image data, structures having pixel intensity values similar or higher than that of blood vessels must be removed by editing.

For this purpose manual editing methods are known which, however, consume expensive machine and operator time, not withstanding that the operator is an expert. U.S. Pat. No. 5,570,404 discloses a method for automatically editing a plurality of CT image slices to provide a three-dimensional view of a selected object located within a patient's body. The method comprises providing at least one slab of CT image slices produced by a CT scanning system and computing a top MIP image of the slab. An undesirable object is automatically removed from the top MIP image by first detecting all the pixels having illuminating intensity values which represent the undesirable object. Then all the pixels of the object to be removed are set to substantially zero illuminating intensity value in order to remove the object from the top MIP image of the slab. After the undesirable object is removed from the top MIP image, the edits made thereto are applied to each CT image slice in the slab. Further, a corresponding apparatus for performing 3D reconstruction of CT angiographic images is disclosed.

A problem still exists when a projection image of the object of interest obtained from a 3D image data set shall be updated, i.e. if a projection image shall be obtained and displayed showing the object of interest from the same viewing angle than the previous projection image, but showing more or less image objects. Generally, this requires the generation of a completely new projection image, for instance by use of a ray-casting method, and thus an associated computational cost, which limits the amount of interaction possible when editing an object of interest.

It is an object of the present invention to provide a more efficient image processing apparatus and method which reduce the computational costs for updating a projection image of an object of interest.

This object is achieved according to the present invention by an image processing apparatus as claimed in claim 1 comprising:

a segmentation unit for segmentation of said 3D image data set to obtain a segmented 3D image data set,

a labelling unit for labelling image voxels of the same image objects of the segmented 3D image data set to obtain labelled image objects,

an image generator for generating projection images of said labelled image objects and of the background from said predetermined viewing angle,

a selector for selecting one or more of said projection images for display,

an image processor for generating the final projection image for display by combining the selected projection images.

A corresponding image processing method is defined in claim 7. A computer program comprising program code means for causing a computer to carry out the steps of said method when said computer program is run on a computer is defined in claim 8.

The invention is based on the insight that there is a correspondence between relations in the 3D image data set and relations in the projection image. A number of projection images are generated for previously segmented and labelled image objects contained in the 3D image data set, i.e. a set of layers characterizing the projections of each segmented and labelled image object individually are obtained. Further, a projection image of the background is obtained, i.e. a background projection image consisting of the view with all segmented and labelled image objects suppressed. All projection images are generated from the same predetermined viewing angle. Thus, a data structure is generated which efficiently represents this set of images, also called multi-layered projection image. A final projection image from the predetermined viewing angle is then obtained by combining selected projection image from this representation or data structure, i.e. one or more of the projection images of this data structure can be selected for display in the combined final projection image.

Thus, the generation of said projection images of said image objects and of the background, for instance by use of a ray-casting operation, is required only once per viewing geometry, and thereafter the final projection image can be rapidly updated simply by adding/removing the individual segmented object layers from the background view. The required number of update operations is reduced by orders of magnitude, from the number of voxels to the number of objects along a given projection ray. The invention thus proposes an efficient method and apparatus to update projection visualisations of segmented object data, enabling real-time, interactive editing of the contents of a projection view.

Preferred embodiments of the invention are defined in the dependent claims. As mentioned above, in a preferred embodiment the image generator is adapted for generating multiple intensity projection images. However, the invention is generally also applicable with other image generating means which are adapted for generating other kinds of projecting images, such as volume rendering images.

In case of MIP images it is preferred that the image processor adapted for generating the final projection image by selecting for each image pixel of said final projection image the maximum pixel value from the same image pixels of the selected projection images for display. This is a very simple and cost-effective method of generating the final projection image. No additional ray casting operation is required, but a simple selection of the maximum pixel value is required from among the pixel values of all selected projection images. Updating the objects shown in a projection image from a given viewing angle, can thus be performed in real-time and interactively.

In a further embodiment of the invention a viewing angle selector is provided for selecting the viewing angle from which the final projection image for display shall be viewed. This selector might be any interface by which the user can select the viewing angle. Furthermore, in this embodiment a high resolution is used for generating new projection images in areas of the 3D image data set containing image objects, while a low resolution is used in areas containing no image objects. Thus, the knowledge from previously obtained projection images and of a previous segmentation about the location of image objects within the 3D image data set is exploited when generating the new projection images in order to reduce the number of operations for obtaining the pixel values of the projection images in areas where, in fact, no image object is present in a particular projection image. In this way, the number of computations can be considerably reduced for obtaining a final projection image after selection of a new viewing angle.

The present invention will now be explained in more detail with reference to the drawings in which

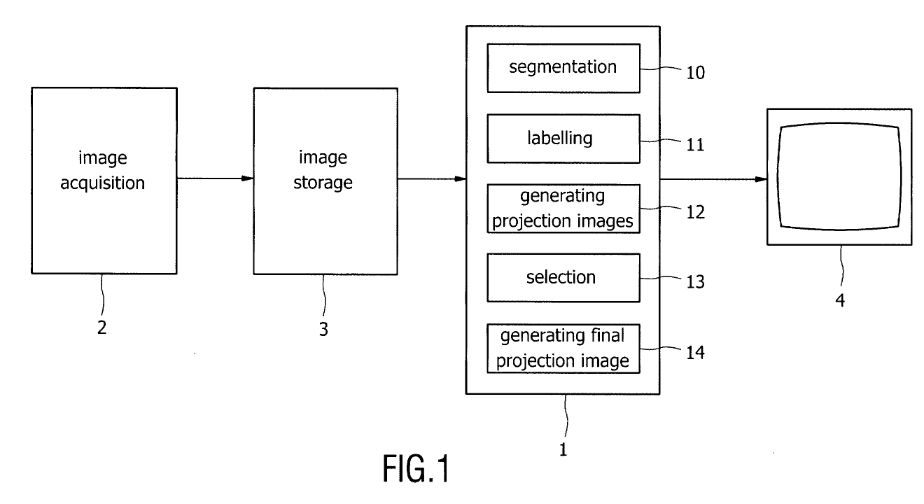

FIG. 1 schematically shows an image processing apparatus according to the present invention,

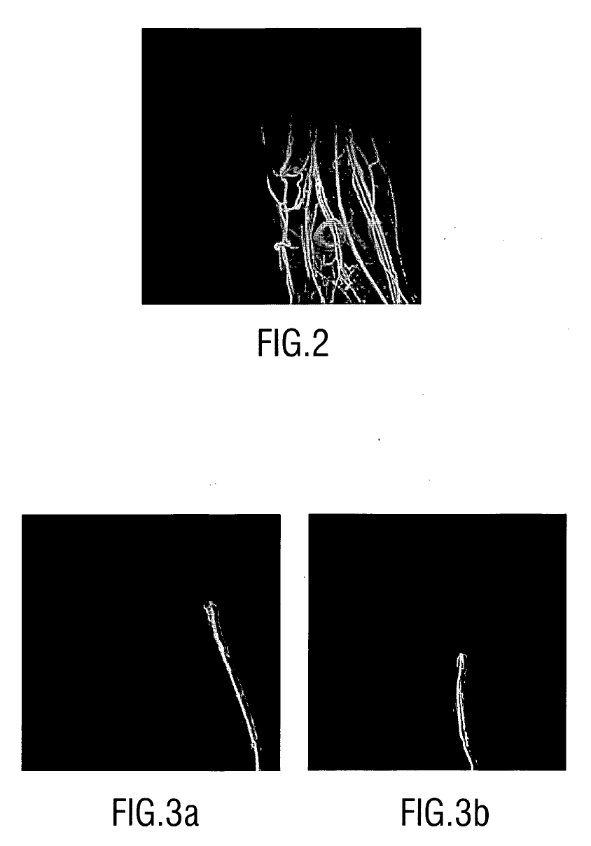

FIG. 2 shows a full MIP image of an object of interest,

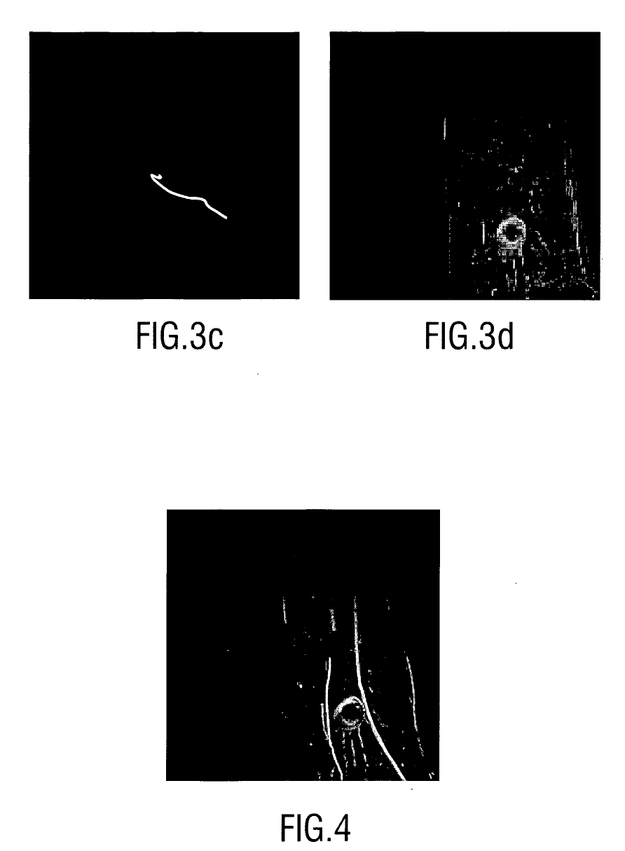

FIG. 3 shows three projection images of segmented objects of interest and a projection image of the background and

FIG. 4 shows a final projection image obtained by combining some of the projection images shown in FIG. 3.

In the block diagram of FIG. 1 an image processing apparatus 1 according to the present invention is schematically shown. Further shown is an image acquisition means 2 which can be any means for acquiring 3D image data of an object of interest. To mention some embodiments, the image acquisition means can be a CT device, an X-ray device enabling rotational angiography, an MR apparatus or an ultrasound apparatus, preferably for obtaining image data of a patient. However, generally the image acquisition means 2 can also be adapted for acquiring 3D image data of an object of interest in the industrial field, such as a cast part. Furthermore, any kind of image acquisition modality can be used.

The obtained 3D image data set is generally stored in an image storage 3 which can be a server or a computer network, the hard disc of a workstation or any kind of storage means, such as a record carrier.

Still further, a display means 4 is shown for display of one or more projection images, in particular the final projection image obtained. Furthermore, means for interactively editing and/or controlling the image processing or display might be displayed on the display 4, which is preferably a computer monitor.

The image processing apparatus 1, which could be a workstation or a PC, comprises a segmentation unit 10 for segmentation of a 3D image data set of an object of interest obtained, for instance, from the image storage 3. For the segmentation any kind of segmentation method can generally be applied. How to segment a 3D image data set is generally known in the art and shall thus not be explained in more detail. As a result of the segmentation voxels of the 3D image data set which are considered to belong to same image structure, or group of structures, are marked as belonging to this object, while other voxels considered not to be part of the object, i.e. a segemented 3D image data set is obtained.

In a labelling unit 11 image voxels of the same image objects of the segmented 3D image data set are then labelled accordingly which can be done automatically or interactively by the user. Thus, image voxels of the same image objects are labelled by the same label. For instance, all veins are labelled by a first label, all arteries are labelled by a second label, a first bone is labelled by a third label and so on. A full projection image of such a segmented and labelled image data set of a patient's foot showing the segmented and labelled veins and arteries, i.e. the segmented and labelled image objects is depicted in FIG. 2.

Thereafter in image generating means projection images of the segmented and labelled image objects and of the background (consisting of the view with all segmented and labelled image objects suppressed) are generated by an image generator 12. Such projection images can, for instance, be multiple intensity projection images as shown in FIGS. 3a to 3c for three different image objects (veins in this case) and as shown in FIG. 3d for the background. However, any other kind of projection scheme might equally be applied, such as volume rendering projection images. These projection images are obtained by any kind of image projection operation, for instance a ray-casting operation as they are generally known in the art and which shall therefore not be explained in more detail here. Such a ray-casting operation is, for instance, explained in V. Pekar et al., “Efficient visualisation of large medical image datasets on standard PC hardware”, Proceedings data visualisation 2003, pp. 135-140, Grenoble, France. The generated projection images all provide a view on the image object or the background, respectively, from the same, predetermined viewing angle.

By use of a selector 13 one or more of said projection images generated by image generator 12 can be selected for display, preferably in a combined, final projection image. This selector 13 can either be adapted such that it provides the ability for a user to interactively select which image objects shall be displayed and which shall be suppressed. In other embodiments the selector 13 can be adapted to make this selection automatically based on previously made settings or selection criteria, which could be, for instance, to display all veins, but no arteries or which could be to display all vessels, but no bones.

Based on the selection the final projection image is obtained by combining the selected projection images in an image processor 14. This can be easily done by simply selecting for each image pixel of the final projection image the maximum image value of the same image pixel from among the selected projection images in case of MIP. Of course, in case of other projections different criteria or algorithms may be applied for determining the image values in the final projection image from among the image values of the selected projection images. For instance, an appropriate weighing can be applied in case of a volume rendering image. But in any case the non-selected image projections are not taken into account during generation of the final projection image, and it is further not required to perform a ray-casting operation for generating the final projection image.

A final projection image which is obtained by combination of the projection images shown in FIGS. 3a, 3b and 3d is depicted in FIG. 4. It is now easily possible to update this final projection image, i.e. to insert or suppress other image objects which have been segmented and labelled earlier and for which a separate projection image exists. For instance, the user might select by use of the selector 13 that other image objects, e.g. the image object shown in FIG. 3, shall be displayed in the final projection image. Thus, updating of the final projection image with the same viewing geometry is easily and in real-time possible with the present invention.

The information obtained from the generation of projection images of image objects from a first viewing angle can also be exploited further when a new final projection image shall be generated from a different viewing angle. For instance, it is often required that the displayed object of interest shall be rotated and that at intervals of a certain number of degrees a new final projection image shall be displayed. The projection images of the separate image objects contain an information in which areas of the volume covered by the 3D image data set image objects are present. It is now possible for obtaining new projection images from a new viewing angle (e.g. after rotation) to perform a ray-casting operation with a high number of rays where an image object is present and will result in corresponding image values in the projection image to be generated for that image object, while in areas where no object is present less rays can be used. Thus, also for generating new final projection images from new viewing angles the invention leads to a reduction of the number of operations and thus computation time.

The image processing apparatus and the elements thereof can be part of a workstation or PC or can be distributed over several computers. Furthermore, the elements of the invention can be implemented as hardware or software, for instance as separate computer programs or one common software for carrying out the explained functions.

1. Image processing apparatus for processing a 3D image data set of an object of interest and for providing a projection image of said object of interest from a predetermined viewing angle for display comprising:
a segmentation unit for segmentation of said 3D image data set to obtain a segmented 3D image data set,
a labelling unit for labelling image voxels of the same image objects of the segmented 3D image data set to obtain labelled image objects,
an image generator for generating projection images of said labelled image objects and of the background from said predetermined viewing angle,
a selector for selecting one or more of said projection images for display,
an image processor for generating the final projection image for display by combining the selected projection images.

2. Image processing apparatus as claimed in claim 1, wherein said image generator is adapted for generating multiple intensity projection images.

3. Image processing apparatus as claimed in claim 2, wherein said image processor are adapted for generating the final projection image by selecting for each image pixel of said final projection image the maximum pixel value from the same image pixels of the selected projection images for display.

4. Image processing apparatus as claimed in claim 1, wherein said image generator is adapted for generating volume rendering images.

5. Image processing apparatus as claimed in claim 1, further comprising a viewing angle selector for selecting the viewing angle from which the final projection image for display shall be viewed,
wherein said image generator is adapted for generating new projection images of the same object of interest from a newly selected viewing angle by using a high resolution in areas of said 3D image data set containing image objects and by using a low resolution in areas of said 3D image data set containing no image objects.

6. Image processing apparatus as claimed in claim 1, wherein said image generator is adapted for generating said projection images by using a ray casting method.

7. Image processing method for processing a 3D image data set of an object of interest and for providing a projection image of said object of interest from a predetermined viewing angle for display comprising the steps of:
segmentation of said 3D image data set to obtain a segmented 3D image data set,
labelling image voxels of the same image objects of the segmented 3D image data set to obtain labelled image objects,
generating projection images of said labelled image objects and of the background from said predetermined viewing angle,
selecting one or more of said projection images for display,
generating the final projection image for display by combining the selected projection images.

8. Computer program comprising program code means for causing a computer to carry out the steps of the method as claimed in claim 7 when said computer program is run on a computer.
